(19) United States
(12) Patent Application Publication
(10) Pub. No.: US 2010/0100492 A1
(43) Pub. Date: Apr. 22, 2010

(54) SHARING TRANSACTION INFORMATION IN A COMMERCE NETWORK

(76) Inventors: Philip Law, Sunnyvale, CA (US); Rolf Skyberg, Campbell, CA (US); Trisha Lee Okubo, San Jose, CA (US); Choon Chong, San Francisco, CA (US); Yuan Der Ho, San Matteo, CA (US)

Correspondence Address: SCHWEGMAN, LUNDBERG & WOESSNER/EBAY, P.O. BOX 2938, MINNEAPOLIS, MN, 55402, US

(21) Appl. No.: 12/252,663

(22) Filed: Oct. 16, 2008

(51) Int. Cl. G06Q 99/00

(52) U.S. Cl. 705/319

(57) ABSTRACT

A computerized method and system for creating and maintaining a commerce network data structure are provided. Example embodiments may include receiving transaction information related to a business relationship between a first user and a business entity. The business relationship between the first user and the business entity may be verified using the transaction information. A commerce network data structure may be created. The commerce network data structure may include a link between a first node and a second node. The first node may represent the first user, the second node may represent the business entity, and the link may represent the business relationship. A communication including a request for the transaction information related to the business relationship may be received from the second user. Responsive to the receiving of the communication, the commerce network data structure may be accessed to automatically provide the second user with the transaction information.

### TECHNICAL FIELD

Example embodiments relate generally to the technical field of data management, and in one specific example, to a system and a method for creating and maintaining a commerce network data structure.

### BACKGROUND

Various networks may be modeled by graphs including nodes and links between the nodes. Graphs are often used as an abstraction for modeling relationships between objects in mathematics. However, other modeling applications such as modeling of natural systems (e.g., plants and animals verities, etc.), economies (e.g., national and regional economies, etc.), engineering systems (e.g., power grids, Web, etc.) and social networks (e.g., Facebook.com and mySpace.com) may also use graphs.

Specifically, in social networks, the nodes may be people and the links between the nodes may be social relationships of different types, such as, family member, friend, school mate, team mate, co-worker, etc. Each person may be a member of several networks, such as networks of graduates of a certain school at a certain year, or employees of a business entity, or members of a team, etc. Networks may be connected through common members. Network members may share information as they desire or make their information available to other members of one or more networks.

### BRIEF DESCRIPTION OF THE DRAWINGS

Some embodiments are illustrated by way of example and not limitation in the figures of the accompanying drawings in which:

FIG. 1 is a high-level diagram depicting, in an example embodiment, functionality of a commerce network linked to other commerce and social networks and a commerce network server.

FIG. 2 is a block diagram illustrating an example embodiment of a system for creating and maintaining a commerce network data structure;

FIG. 3 is a block diagram illustrating, in an example embodiment, components of a creation module used in FIG. 2;

FIG. 4 is a high-level flow diagram illustrating an example method for creating and maintaining a commerce network data structure;

FIG. 5 is a sequence diagram illustrating an example method of peer-to-peer communication between members of a commerce network;

FIG. 6 is high-level block diagram illustrating an example embodiment of a commerce network system having a client-server architecture;

FIG. 7 is database schema illustrating an example embodiment of a data structure of a commerce network;

FIG. 8 is an example set of commerce network application used by the commerce network system of FIG. 6;

FIG. 9 is a diagram illustrating a diagrammatic representation of a machine in the example form of a computer system;

FIG. 10 is a screen shot illustrating an example embodiment of a user interface used as a commerce network home page;

FIG. 11 is a screen shot illustrating an example embodiment of a item detail user interface;

FIG. 12 is a screen shot illustrating an example embodiment of a export transaction user interface; and

FIG. 13 is a screen shot illustrating an example embodiment of an add purchase user interface.

### DETAILED DESCRIPTION

Example methods and systems for creating and maintaining a commerce network data structures will be described. In the following description, for purposes of explanation, numerous specific details are set forth in order to provide a thorough understanding of example embodiments. However, it will be evident to one skilled in the art that the present technology may be practiced without these specific details.

Some example embodiments described herein may include receiving transaction information related to a business relationship (e.g., business transaction, affiliation, affinity, etc.) between a first user and a business entity (e.g., a store, a company, a corporation, a firm, an institution, an online business, an online publication system, etc.). The business relationship between the first user and the business entity may be verified using the transaction information.

A commerce network data structure may be created. The commerce network data structure may include a link between a first node and a second node. The first node may represent the first user, the second node may represent the business entity, and the link may represent the business relationship between the first user and the business entity. A communication (e.g., a letter, an email, a voice message, a SMS (Short Messaging system), a facsimile, etc.) including a request for the transaction information related to the business relationship may be received from the second user. Responsive to the receiving of the communication, the commerce network data structure may be accessed to automatically provide the second user with the transaction information.

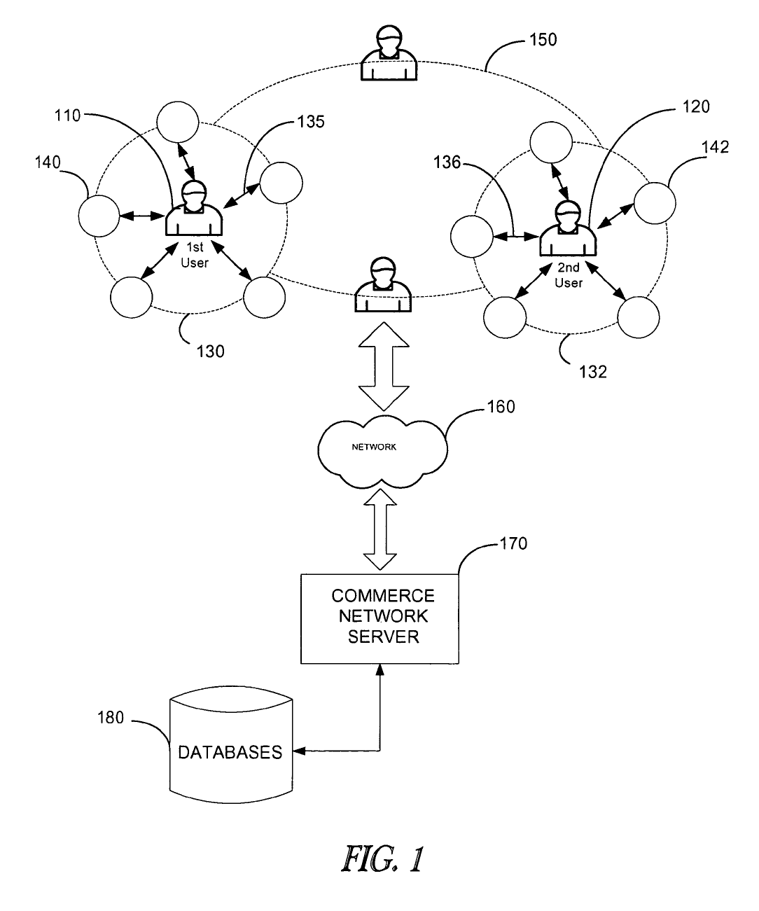

FIG. 1 illustrates a high-level diagram depicting, in an example embodiment, functionality of a commerce network linked to other commerce and social networks and a commerce network server. One or more commerce networks 130 and 132 may include members including a first user 110 and a second user 120. The commerce networks 130 and 132 may include a number of business entities 140 and 142, respectively, who may also be members of other commerce networks as well. The first user 110 and a second user 120 may have business relationship 135 and 136 with business entities 140 and 142, respectively. The first and the second users 110 and 120 may also be members of various commerce or social networks such as a social network 150. Examples of social networks include MySpace.com, LinkedIn, etc. The first and the second users 110 and 120 may be the hubs of their own commerce networks 130 and 132.

In example embodiments, the commerce networks 130 and 132 and the social network 150 may be linked to a commerce network server 170 via a network 160 (e.g., the Internet). The commerce network server 170 may have access to databases 180 for storing/retrieving information related to the commerce networks 130 and 132, social network 150, or other social or commerce networks and their associated members and relationships.

In the example embodiment of FIG. 1, the commerce network server 170 may receive transaction information related to a business relationship 135 between the first user 110 and the business entity 140. The commerce network server 170 may store the transaction information in the databases 180. The business relationship 135 may simply comprise a business transaction. For example, the business transaction may indicate that the first user 110 has purchased a product from the business entity 140 (e.g., a store). The business relationship may also comprise an affiliation or an affinity. For example, first user 110 may be an affiliate of eBay or be interested in doing business using an eBay site. The commerce network server 170 may verify the business relationship 135 between the first user 110 and the business entity 140.

According to an example embodiment, the commerce network server 170 may use the transaction information related to the business relationship 135 to verify the business relationship 135. The verification of the business relationship 135 may include receiving a confirmation of a business relationship from the business entity 140. The confirmation may include evidence confirming the business relationship 135. For example the evidence may include a receipt showing that the first user 110 purchased a product or service from the business entity 140.

The commerce network server 170 may create a network data structure. The network structure may include a link between a first node and a second node. The first node may represent the first user 110; the second node may represent the business entity 140 or 142; and the link may represent the business relationship 135 or 136 between the first user 110 or the second user 120 and the business entity 140 or 142, respectively. In an example embodiment, the commerce networks 130 and 132 may include a number of nodes representing business entities 140 and 142. The commerce network server 170 may store the information related to the network data structure in the databases 180.

The commerce network server 170 may receive a communication from a second user (e.g., the second user 120 or any other user). The communication may include a request for the transaction information related to the business relationship 136. In response to receiving the communication, the commerce network server 170 may access the commerce network data structure to automatically provide the second user 120 with the transaction information. The second user 120 may use the transaction information in a business transaction 136 with the business entity 142. For example, the second user may show an evidence of a price $100 for an item, received from the commerce network server 170, to the business entity 142 to ask the business entity 142 to sell the item to second user at the same price or a price near the $100 price.

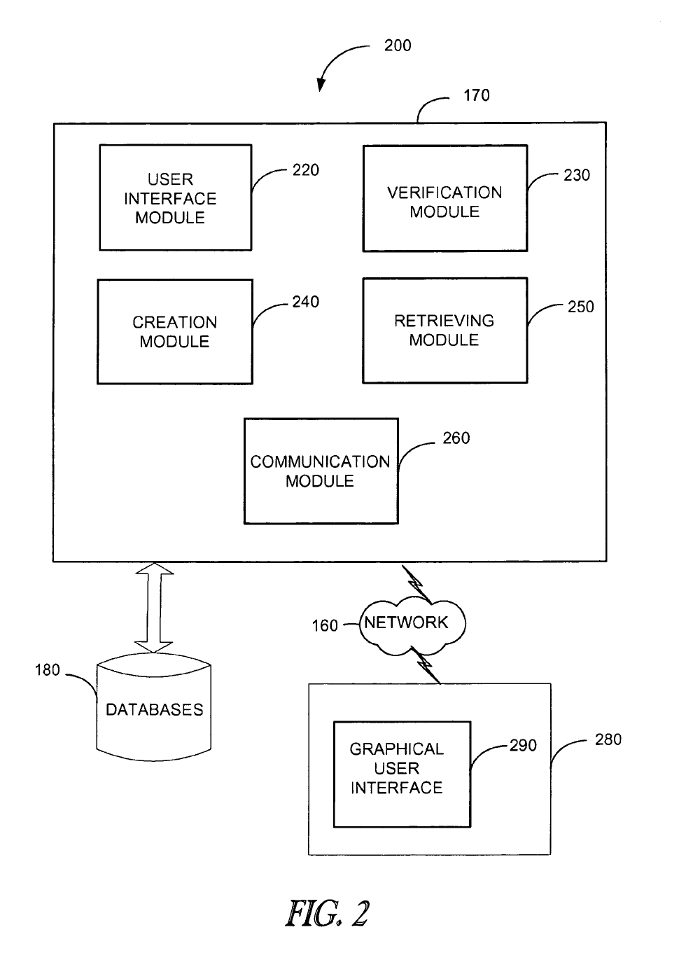

FIG. 2 is a block diagram illustrating an example embodiment of a system 200 for creating and maintaining a commerce network data structure. The system 200 may include the commerce network server 170 linked to a client system 280 via the network 160, and having access to the databases 180. The commerce network 170 may include a user interface module 220, a verification module 230, a creation module 240, a retrieving module 250, and a communication module 260. The user interface module 220 may receive transaction information related to one or more business relationships 135 between the first user 110 and one or more business entities 140 as shown in FIG. 1.

The user interface module 220 may provide the client system 280 with a graphical user interface 290. The user interface module 220 may receive a transaction information from the graphical user interface 290 displayed at client system 280. The transaction information may include a price paid for an item purchased or a service received from the business entity 140, the name of the business entity 140, specifications of one or more products or services purchased, an address of the business entity 140, a feedback received from the first user 110 by the business entity 140, or a feed back received by the first user 110 from the business entity 140, a coupon or a promotion received from the business entity 140, etc.

In example embodiments, the first user 110 or the business entity 140 may use the graphical user interface 290 to enter the transaction information into the commerce network server 170, using the client system 280 and the network 160. The verification module 230 may verify the business relationship between the first user 110 and the one or more business entities 140. The verification module 230 may use a confirmation of the business relationships 135 and 136 received from the business entities 140 and 142 to verify the business relationship.

According to an example embodiment, the verification of the business relationships 135 and 136 may include receiving a communication from the first user 110. The communication may include an evidence confirming the business relationship between the first user 110 and the business entity 140. For example, the evidence may include a receipt showing that the first user 110 purchased an item or received a service from the business entity 140. The verification module 230 may use the commerce network data structure to obtain information related to confirmation of the business relationship including the evidence.

The creation module 240 may create a commerce network data structure. The creation module 240 may create a link between the first node and a second node. The first node may represent the first user 110; the second node may represent the business entity 140; and the link may represent the business relationship 135. In an example embodiment, the creation module 240 may create the link after receiving the verification from the verification module 230. The creation module 240 may store information related to the commerce network data structure in the databases 180.

According to an example embodiment, the communication module 260 may receive a communication from a second user (e.g., the second user 120). The communication may include a request for the transaction information related to the business relationship. The communication module 260 may pass the request to the retrieving module 250. The retrieving module 250, responsive to the request, may access the network data structure from the databases 180 and automatically provide the second user with the transaction information.

In an example embodiment, the retrieving module 250 may pass the transaction information to the communication module 260 to communicate the transaction information to the second user. The second user may use the transaction information in a business transaction 136 with the business entity 142. For example, the second user may show an evidence of a price for an item, received from the commerce network server 170, to the business entity 142 to ask the business entity 142 to sell the item to second user at the same or a close price.

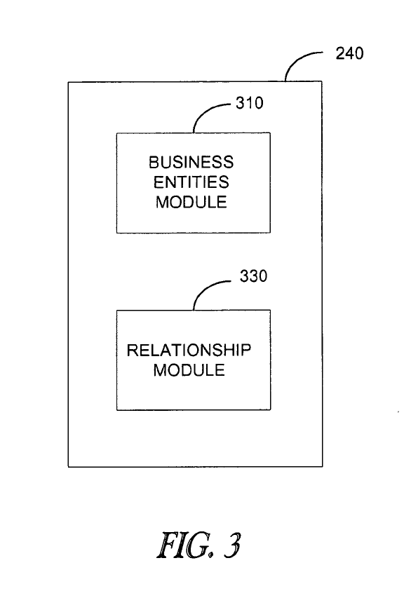

FIG. 3 is a block diagram illustrating, in an example embodiment, components of the creation module 240 used in FIG. 2. The creation module 240 may include a business entities module 310 and a relationship module 330. In an example embodiment, the business entities module 310 may identify a number of business entities 142 and 142 linked to the one or more users (e.g., the first user 110 and the second user 120). The business entities module 310 may also collect data related to one or more business relationships 135 and 136 as shown in FIG. 1. According to an example embodiment, the data may include information related to the business entities 140 or 142, including the type of business, address, contact information, promotional and advertising materials, coupons, etc.

In some example embodiments, the relationship module 330 may detect one or more attributes of the business relationship. The one or more attributes may be detected using the transaction information related to the business relationships 135 and 136. The attributes of the business relationships 135 and 136 may include a strength, a frequency or a feedback. The strength of the business relationships 135 and 136 may be indicated by one or more factors including a dollar amount of one or more transactions, or the duration history of the business relationship. The frequency may be an indication of the number of transaction in a fixed period of time (e.g., one year, 3 year, 5 year, etc.) between the first user 110 and the business entity 140 as shown in FIG. 1. The feedback may be a number of positive or negative feedbacks left by the first user 110 for the business entity 140 or by the business entity 140 for the first user 110.

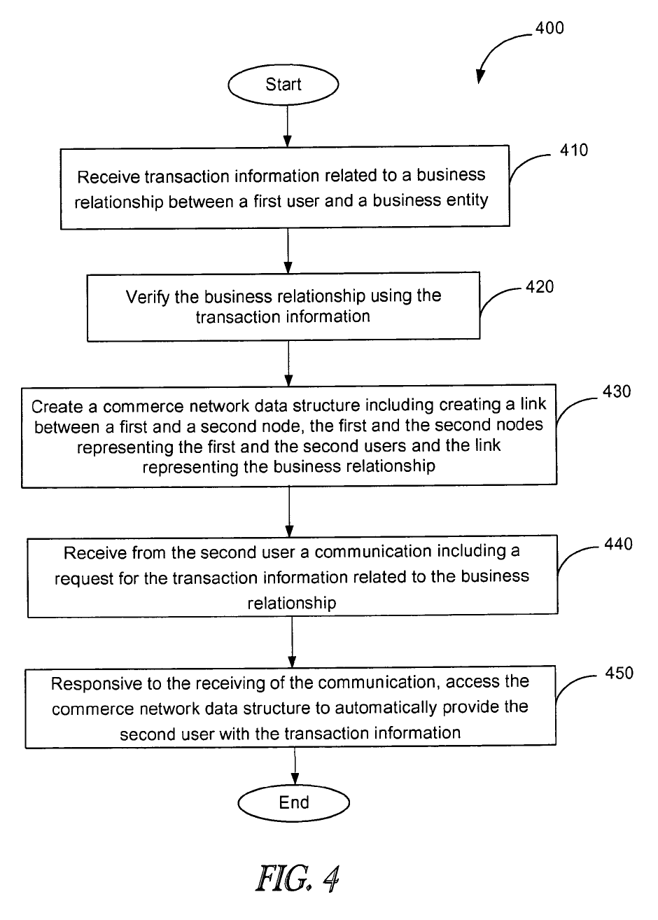

FIG. 4 is a high-level flow diagram illustrating an example method 400 for creating and maintaining a commerce network data structure. At operation 410, the user interface module 220 as shown in FIG. 2, may receive transaction information related to the business relationship 135 between a first user 110 and a business entity 140 as shown in FIG. 1. In example embodiments, the user interface module 220 may receive the transaction information from the first user 110 or the business entity 140.

The verification module 230 as shown in FIG. 2, at operation 420, may verify the business relationship 135 using the transaction information. The transaction information may include a price paid for an item purchased or a service received from the business entity 140, the name of the business entity 140, specification of one or more products purchased or services received, an address of the business entity 140, a feedback received from the first user 110 by the business entity 140, an advertisement, a coupon or a promotional material received from the business entity, etc.

At operation 430, the creation module 240 as shown in FIG. 2, may create a commerce network data structure. The commerce network data structure may include a link between a first and a second node. In example embodiments, the first node may represent the first user 110; the second node may represent the business entity 140; and the link may represent the business relationship 135 between the first user 110 and the business entity 140.

The communication module 260 as shown in FIG. 2, may, at operation 440, receive a communication from a second user 120. The communication may include a request for the transaction information related to the business relationship 135 and pass the request to the retrieving module 250 as shown in FIG. 2. At operation 450, in response to receiving the request, the retrieving module may access the commerce network data structure stored in the databases 180 as shown in FIG. 1, to retrieve the transaction information. The transaction information may be passed to the communication module 260 and automatically communicated to the second user.

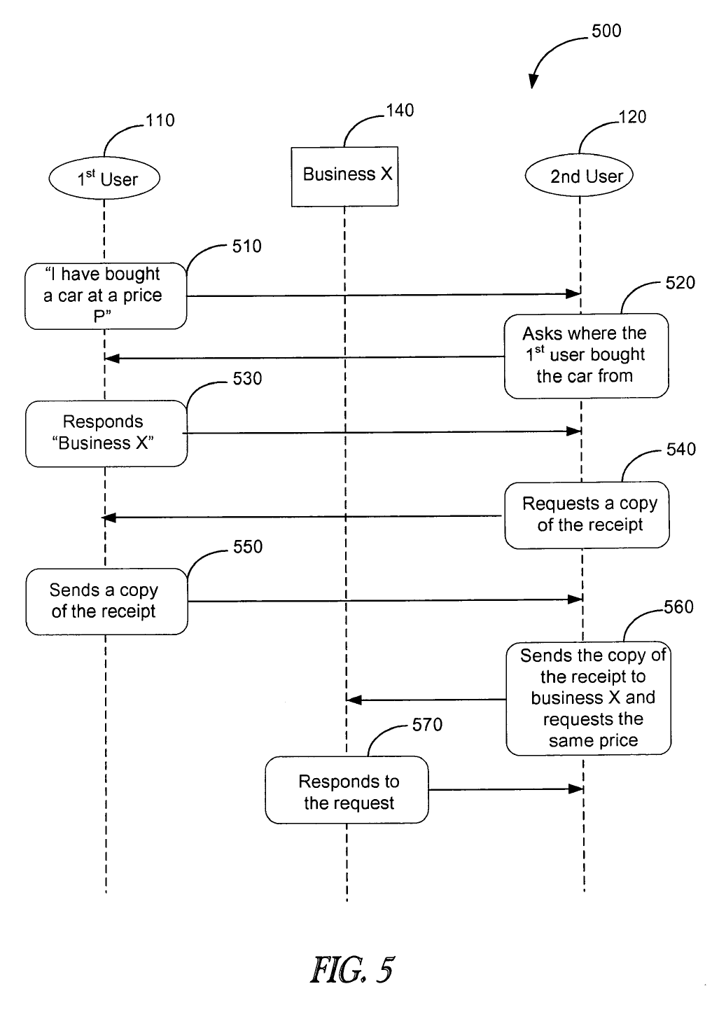

FIG. 5 is a sequence diagram illustrating an example method 500 for peer-to-peer communication between members of a commerce network. The peer-to-peer communication is between the first user 110 and the second user 120, who may be, for example, colleagues, friends or members of a social network and a business X (e.g., business entity 140). At operation 510, the first user 110 may convey to the second user 120 that the first user has purchased a car (e.g., a Toyota Camry) at a price P (e.g., $15,000). The second user 120 may in response ask the first user 110 where the first user has purchased the car from (operation 520).

At operation 530, the first user 110 may respond that the car was purchased from the business X (e.g., such as Toyota dealer in Palo Alto, Calif.). The second user 120, at operation 540, may request the first user 110 to send the second user 120 a copy of the receipt for the car. At operation 550, the first user 110 may send a copy of the receipt to the second user 120. The second user 120 may send the copy of the receipt to the business X and request the business X to agree to sell to the second user 120 a similar car ( same year and model with the same options) at the same price (operation 560). The business X may, at operation 570, respond to the request from the second user 120.

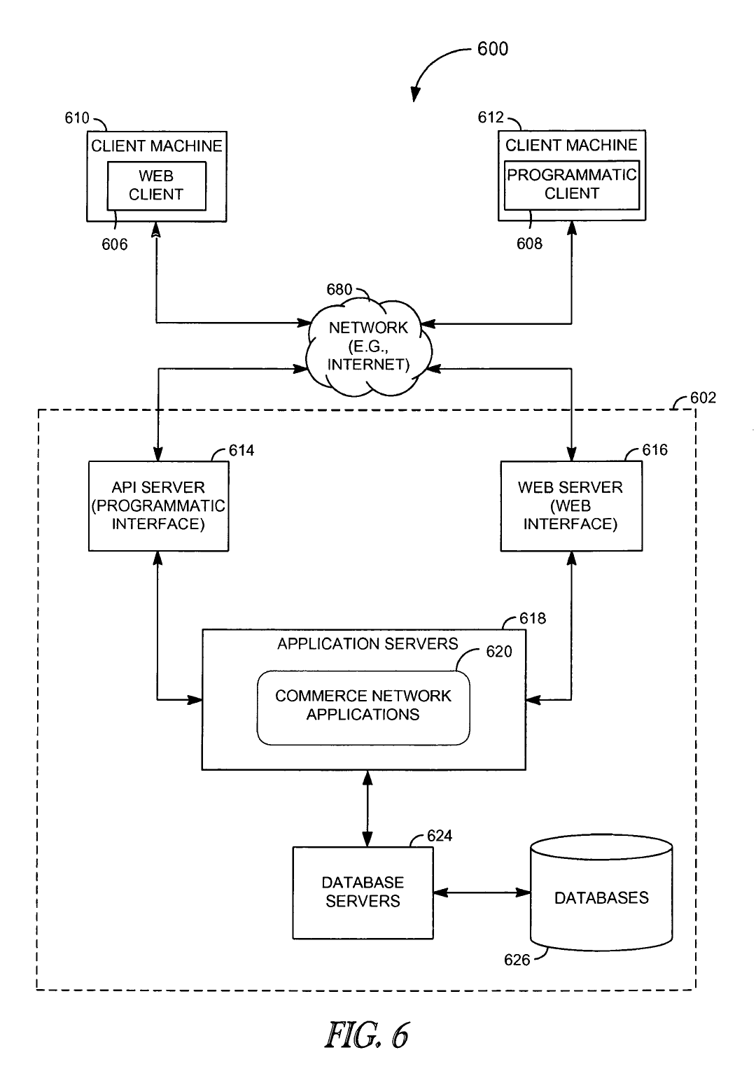

FIG. 6 is high-level block diagram illustrating an example embodiment of a commerce network system 600 having a client-server architecture; A publication platform, in the example form of a commerce network server 602, may provide server-side functionality, via a network 680 (e.g., the Internet) to one or more clients. FIG. 6 illustrates, for example, a Web client 606 (e.g., a browser, such as the Internet Explorer browser developed by Microsoft Corporation of Redmond, Wash.), and a programmatic client 608 executing on respective client machines 610 and 612.

Turning specifically to the commerce network server 602, an Application Program Interface (API) server 614 and a Web server 616 are coupled to, and provide programmatic and Web interfaces respectively to, one or more application servers 618. The application servers 618 host one or more commerce network application 620. The application servers 618 are, in turn, shown to be coupled to one or more database servers 624 that facilitate access to one or more databases 626.

The commerce network application 620 may provide a number of functions and services to users who access the commerce network system 600. For example, the commerce network applications may support posting and browsing information related to commerce network members and business relationships between the members (e.g., transaction information) in the commerce network system 600.

Further, while the commerce network system 600 shown in FIG. 6 employs a client-server architecture, the disclosed system is not limited to such an architecture and could equally well find application in a distributed, or peer-to-peer, architecture system. The various commerce network applications 620 could also be implemented as stand-alone software programs, which do not necessarily have networking capabilities.

The Web client 606 may access the commerce network applications 620 via the Web interfaces supported by the Web server 616. Similarly, the programmatic client 608 may access the various services and functions provided by the commerce network applications 620 via the programmatic interfaces provided by the API server 614. The programmatic client 608 may, for example, be a search application to enable users of the commerce network to search for information in the commerce network system 600. In another example embodiment, the programmatic client 608 may support users by facilitating posting information (e.g., transaction information, coupons, promotional and advertising material, etc.) in the commerce network system 600.

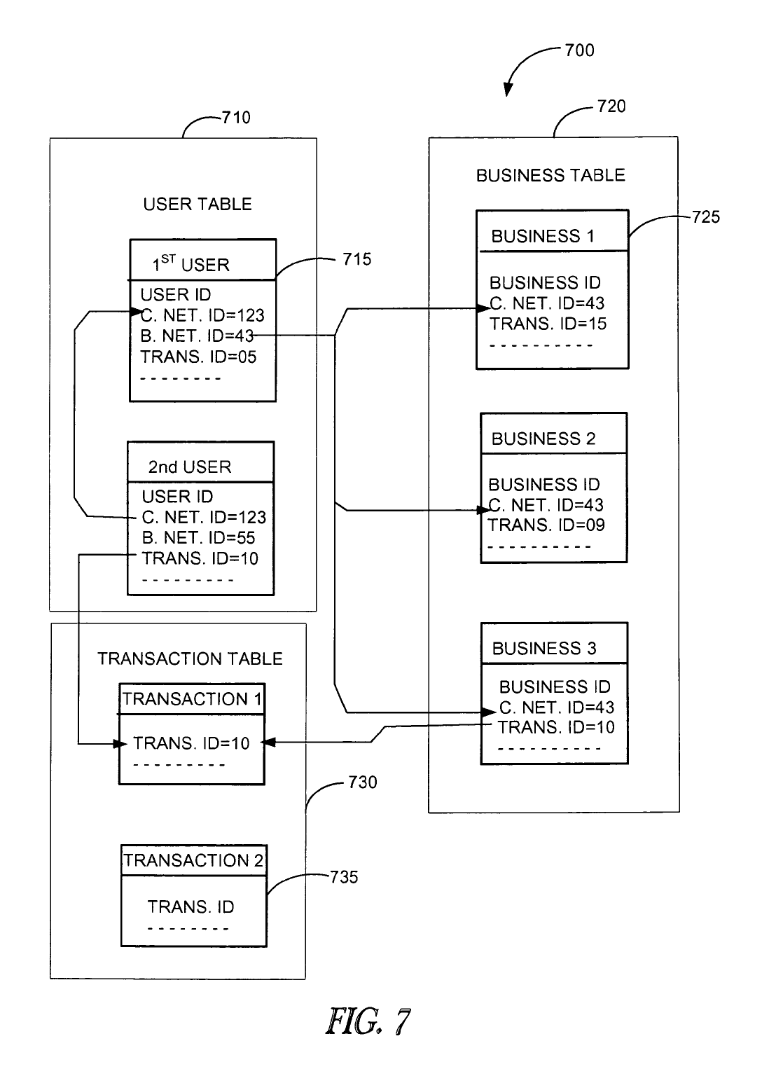

FIG. 7 is database schema illustrating an example embodiment of a data structure 700 of a commerce network. The data structure 700 may include a user table 710, a business table 720, and a transaction table 730. The user table 710 may include a number of user records, such as a first user record 715. Each user record may include a number of fields such as a user ID, a social network ID (e.g., S.NET.ID), a commerce network ID (e.g., C.NET.ID), a transaction ID (e.g., TRAN.ID), and other fields containing data related to users of a commerce network. The business table 720 may include a number of records 725 containing fields such as business ID, commerce network ID, transaction ID, and other field storing more information related to the business members of the social network. The transaction table 730 may include transaction records, such as a transaction record 735. Each transaction record may include a transaction ID field and some more fields containing transaction information related to transactions between the users and the business members of the commerce network.

Various records of the tables 710, 720 and 730 are linked via common ID fields. For example, the first user record 715 is linked to the records associated with businesses 1-3 via a common commerce network ID filed (e.g., C.NET.ID=43). This indicates that the businesses 1-3 and the first user may be members of a commerce network with C.NET.ID of 43. Also, business 3 may be involved in a transaction associated with transaction 1, because the records associated with business 3 and transaction 1 include and are linked via a transaction ID of 10 (e.g., TRANS.ID=10). Similarly, the second user record is shown to have a link via the same transaction ID of 10 (e.g., TRANS.ID=10) with transaction 1. The links via the TRANS.ID of 10 between the second user, business 3, and transaction 1 may also indicate that the second user has been involved in a transaction with business 3 and the information related to the transaction may be found in the record associated with transaction 1.

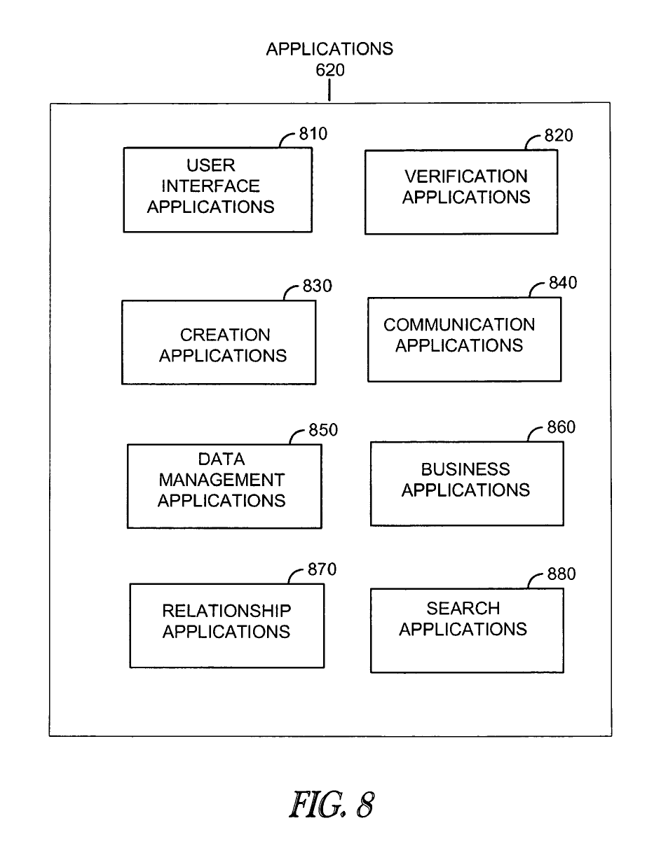

FIG. 8 is an example set of commerce network application 620 used by the commerce network system 600 of FIG. 6. The commerce network application 620 may facilitate and support various functions performed by the commerce network system 600.

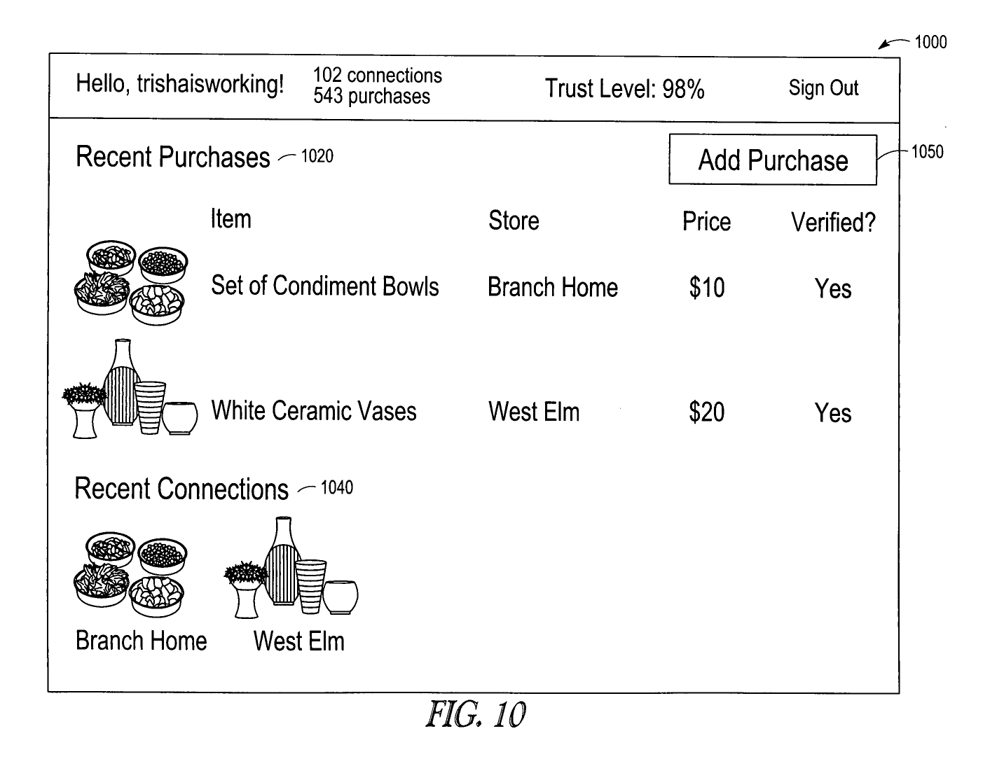

The user interface applications 810 may display various user interfaces (see, for example, FIGS. 10-13) for interacting with users of the commerce network. The user interface applications 810 may also support receiving transaction information related to business relationships between users (e.g., the first user 110, and the second user 120) and business members (e.g., business entities 140) of a commerce network using the commerce network system 600.

One or more verification applications 820 may provide support for verifying business relationships between the users and business members of the commerce network. Creation applications 830 may facilitate creating of a commerce network data structure including data related to users, business members and relationships between the users and the business members of the commerce network using the commerce network system 600.

Communication applications 840 may facilitate communication between users of the commerce network system 600. The communication applications 840, for example, may support receiving requests for transaction information related to the business relationships between the users and business members of the commerce network using the commerce network system 600. The communication applications 840 may also support communication between the users and business members with the commerce network system 600.

Various data management applications 850 may provide support for handling data, including storing and retrieving data related to commerce network data structure created and used by the commerce network system 600. The data management applications 850 may also facilitate categorizing the commerce network data and storing the data in suitable tables and records of the databases 626 as shown in FIG. 6.

On or more business applications 860 may support identifying a number of businesses which are linked to one or more users of the commerce network through business transactions. The business applications may also collect information related to the business members and business relationships between the users and business members of the commerce network and pass the information to the data management applications 850 for categorizing and storing in the databases 626.

Business relationship applications 870 may support detecting attributes of the business relationships between the users and business members of the commerce network. The attributes may indicate a strength, a frequency, or a feedback as discussed above under description of FIG. 3.

A number of search applications 880 may support searching the databases 626 of the commerce network system 600 for data information stored by the commerce network data structure, using search criteria received from a user of the commerce network system 600.

### Machine Architecture

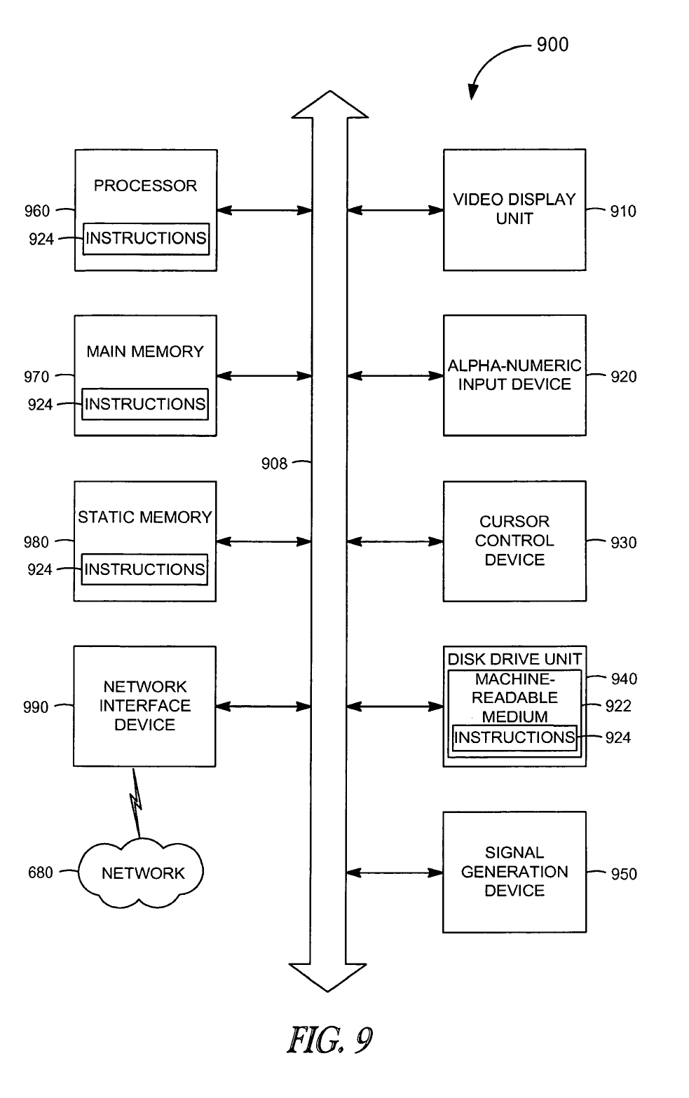

FIG. 9 is a diagram illustrating a diagrammatic representation of a machine 900 in the example form of a computer system, within which a set of instructions for causing the machine to perform any one or more of the methodologies discussed herein may be executed. In alternative embodiments, the machine 900 may operate as a standalone device or may be connected (e.g., networked) to other machines. In a networked deployment, the machine 900 may operate in the capacity of a server or a client machine in a server-client network environment, or as a peer machine in a peer-to-peer (or distributed) network environment.

The machine 900 may be a server computer, a client computer, a personal computer (PC), a tablet PC, a set-top box (STB), a Personal Digital Assistant (PDA), a cellular telephone, a Web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 900 may include a processor 960 (e.g., a central processing unit (CPU), a graphics processing unit (GPU) or both, a main memory 970 and a static memory 980, all of which communicate with each other via a bus 908. The computer system 900 may further include a video display unit 910 (e.g., a liquid crystal display (LCD) or cathode ray tube (CRT)). The computer system 900 also may include an alphanumeric input device 920 (e.g., a keyboard), a cursor control device 930 (e.g., a mouse), a disk drive unit 940, a signal generation device 950 (e.g., a speaker) and a network interface device 990.

The disk drive unit 940 may include a machine-readable medium 922 on which is stored one or more sets of instructions (e.g., software 924) embodying any one or more of the methodologies or functions described herein. The software 924 may also reside, completely or at least partially, within the main memory 970 and/or within the processor 960 during execution thereof by the computer system 900, with the main memory 970 and the processor 960 also constituting machine-readable media.

The software 924 may further be transmitted or received over a network 680 via the network interface device 990.

While the machine-readable medium 922 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding, or carrying a set of instructions for execution by the machine and that cause the machine to perform any one or more of the methodologies of the present subject matter. The term “machine-readable medium” shall accordingly be taken to include, but not be limited to, solid-state memories and optical and magnetic media.

### User Interfaces

FIG. 10 is a screen shot illustrating an example embodiment of a user interface 1000 used as a commerce network home page. The user interface 1000 shows recent business transactions (e.g., recent purchases 1020) and recent business relationships (e.g., recent connections 1040). In the example shown by the user interface 1000, the recent purchases 1020 and the recent connections 1040 are associated with a first user (e.g., Trisha). Trisha has purchased two items from two business entities (e.g., Branch Home, and West Elm).

Transaction information such as price and verification status (e.g., “Verified?”, as shown in FIG. 10) are also shown. The icons under the recent connections 1040 are related to the business entities Branch Home and West Elm. A user may find more information related to Trisha's business relationship with each of these business entities by clicking on the respective icons. Trisha may add new purchases by using the add purchase tab 1050.

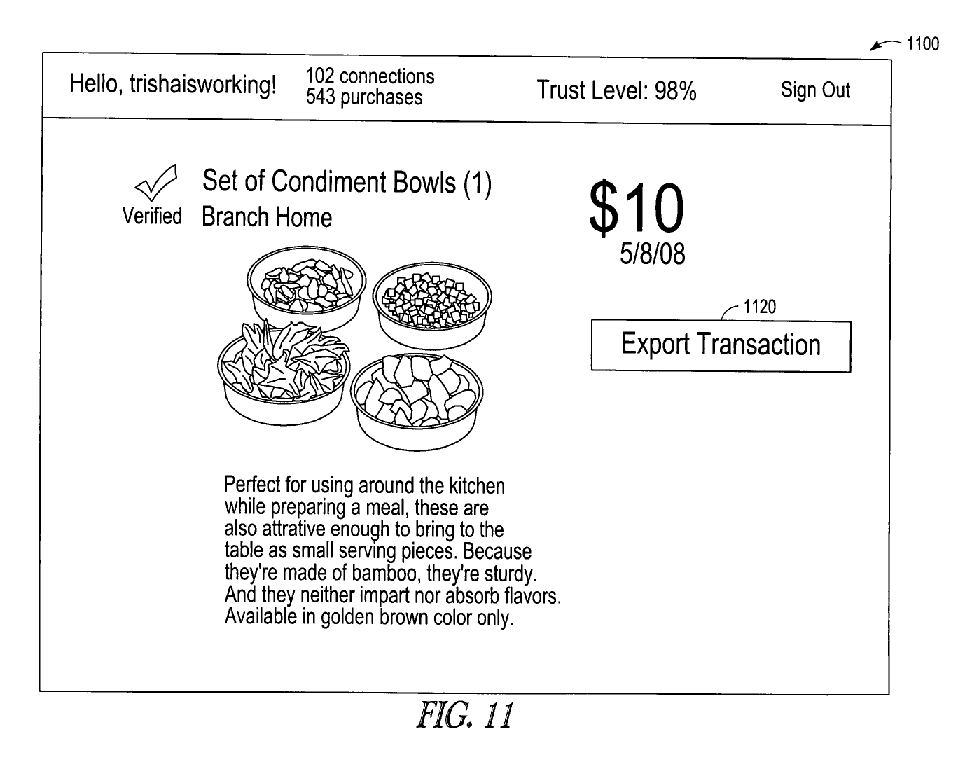

FIG. 11 is a screen shot illustrating an example embodiment of an item detail user interface 1100. Using the user interface 1100, a first user (e.g., Trisha) may see details of each of the items shown in FIG. 10. Trisha may use the export transaction tab 1120 to export transaction information related to the shown item. The user interface also shows that the commerce network server (e.g., the commerce network server 602 as shown in FIG. 6) has verified the transaction information related to the shown item.

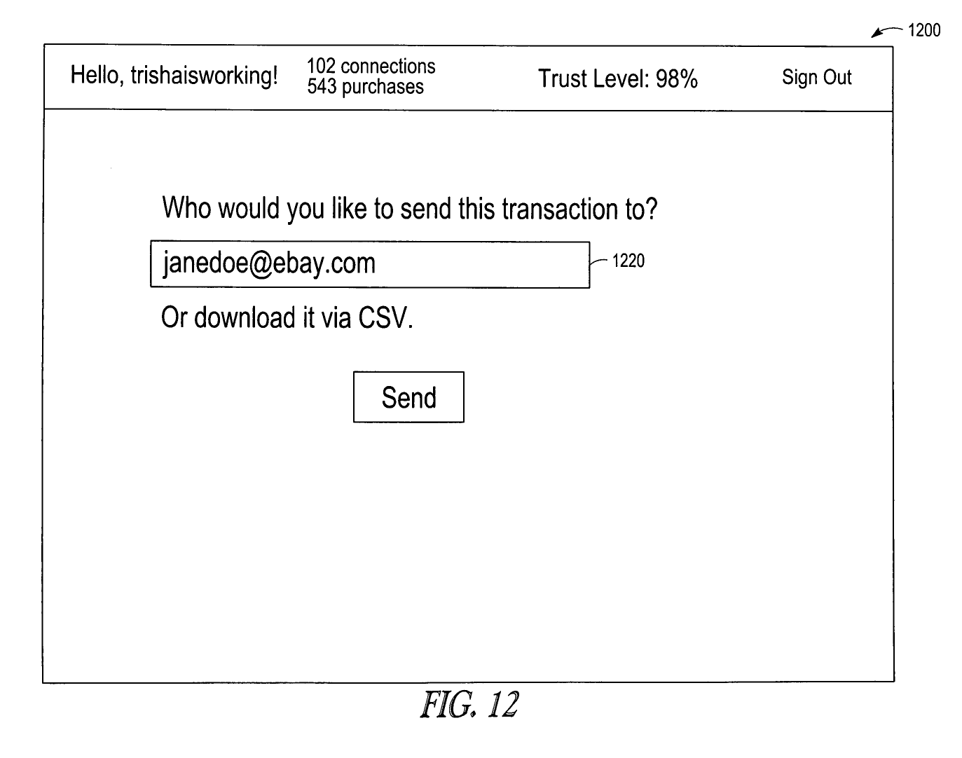

FIG. 12 is a screen shot illustrating an example embodiment of an export transaction user interface 1200. The export transaction user interface 1200 allows a first user (e.g., Trisha) to export the transaction information related to the item shown in the user interface 1100. Trisha may export the transaction information to another user by entering an email address (e.g., janedoe@ebay.com) in to the address box 1220. In another example embodiment, Trisha may export the transaction information via Certified Server Validation (CVS).

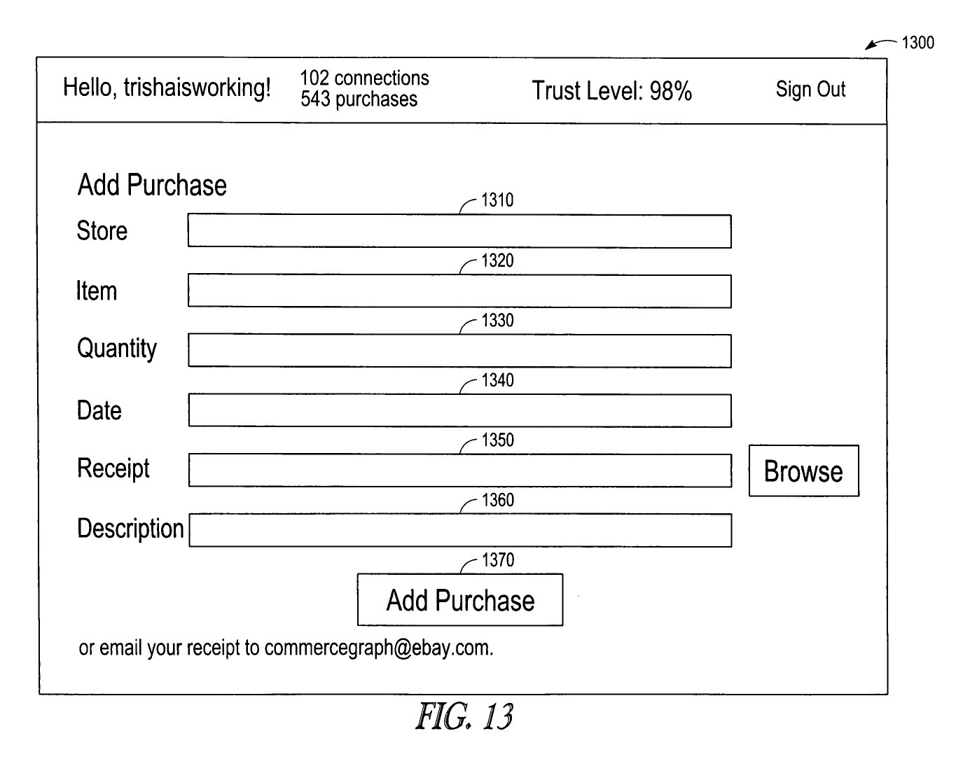

FIG. 13 is a screen shot illustrating an example embodiment of an add purchase user interface 1300. Using the user interface 1300, a first user (e.g., Trisha) may add new transaction information by entering information such as a store name, an item name, a quantity of an item, a date of purchase, a receipt number, and a description of the item in windows 1310, 1320, 1330, 1340, 1350, and 1360, respectively. Trisha may then press the add purchase button 1370 to cause the transaction information to be entered into the commerce network server (e.g., an eBay server). Alternatively, Trisha may email a copy of a receipt including all or parts of the transaction information to the commerce network server.

Thus, a method and a system for creating and maintaining a commerce network data structure have been described. Although the present technology has been described with reference to specific example embodiments, it will be evident that various modifications and changes may be made to these embodiments without departing from the broader spirit and scope of the subject matter. Accordingly, the specification and drawings are to be regarded in an illustrative rather than a restrictive sense.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it may be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separate embodiment.

What is claimed is:

1. A computerized method, said computerized method comprising:
receiving transaction information related to a business relationship between a first user and a business entity;
verifying the business relationship between the first user and the business entity using the transaction information;
creating a commerce network data structure including creating a link between a first node and a second node, the first node representing the first user, the second node representing the business entity, and the link representing the business relationship;
receiving from a second user a communication including a request for the transaction information related to the business relationship; and
responsive to the receiving of the communication, accessing the commerce network data structure to automatically provide the second user with the transaction information.

2. The computerized method of claim 1, wherein the creating of the link is performed responsive to the verifying of the business relationship.

3. The computerized method of claim 1, wherein the verifying of the business relationship is performed using the commerce network data structure.

4. The computerized method of claim 1, wherein the verifying of the business relationship includes receiving a confirmation of the business relationship from the business entity.

5. The computerized method of claim 1, wherein the verifying of the business relationship includes receiving a second communication from the first user, the second communication including evidence confirming the business relationship.

6. The computerized method of claim 1, wherein the first user and the second user are members of a social network.

7. The computerized method of claim 1, wherein the first user is a hub of the commerce network data structure.

8. The computerized method of claim 1, wherein the second user is a hub of a separate commerce network data structure.

9. The computerized method of claim 1, wherein the commerce network data structure includes a plurality of nodes representing a plurality of business entities that are linked to at least one of the first or the second user.

10. The computerized method of claim 1, wherein the creating of the commerce network data structure includes identifying a plurality of business entities linked to the at least one of the first or the second user and collecting data related to the at least one business relationship.

11. The computerized method of claim 1, said computerized method further comprising:
automatically detecting an attribute of the business relationship using the transaction information related to the business relationship.

12. The method of claim 11, wherein the attribute of the business relationship includes at least one of a strength, a frequency, or a feedback.

13. The method of claim 1, wherein the business relationship includes at least one of a business transaction, an affiliation, or an affinity.

14. The method of claim 1, wherein the transaction information includes at least one of a price, a name of the business entity, a product, a service, an address or a feedback.

15. The method of claim 1, wherein the second user uses the transaction information in a business transaction with the business entity.

16. A system, said system comprising:
a user interface to receive transaction information related to a business relationship between a first user and a business entity;
a verification module to verify the business relationship between the first user and the business entity using the transaction information;
a creation module to create a commerce network data structure including creating a link between a first node and a second node, the first node representing the first user, the second node representing the business entity, and the link representing the business relationship;
a communication module to receive from a second user a communication including a request for the transaction information related to the business relationship; and
a retrieving module to access the commerce network data structure, responsive to the receiving of the communication, to automatically provide the second user with the transaction information.

17. The system of claim 16, wherein the creation module is to create the link responsive to a verification by the verification module of the business relationship.

18. The system of claim 16, wherein the verification module is to verify the business relationship using the commerce network data structure.

19. The system of claim 16, wherein the verification module is to verify the business relationship including using a confirmation of the business relationship received from the business entity.

20. The system of claim 16, wherein the verifying of the business relationship includes receiving a communication from the first user, the communication including evidence confirming the business relationship.

21. The system of claim 16, said system further comprising:
a business entities module to identify a plurality of business entities linked to the at least one of the first or the second user and to collect data related to the at least one business relationship.

22. The system of claim 16, said system further comprising:
a relationship module to detect an attribute of the business relationship using the transaction information related to the business relationship, wherein the attribute of the business relationship includes at least one of a strength, a frequency, or a feedback.

23. A system, said system comprising:
means for receiving transaction information related to a business relationship between a first user and a business entity;
means for verifying the business relationship between the first user and the business entity using the transaction information;
means for creating a commerce network data structure including creating a link between a first node and a second node, the first node representing the first user, the second node representing the business entity, and the link representing the business relationship;
means for receiving from a second user a communication including a request for the transaction information related to the business relationship; and
means for accessing the commerce network data structure, responsive to the receiving of the communication, to automatically provide the second user with the transaction information.

24. A machine-readable medium comprising instructions, which when implemented by one or more processors perform the following operations:
receiving transaction information related to a business relationship between a first user and a business entity;
verifying the business relationship between the first user and the business entity using the transaction information;
creating a commerce network data structure including creating a link between a first node and a second node, the first node representing the first user, the second node representing the business entity, and the link representing the business relationship;
receiving from a second user a communication including a request for the transaction information related to the business relationship; and
responsive to the receiving of the communication, accessing the commerce network data structure to automatically provide the second user with the transaction information.

25. The machine-readable medium of claim 24, wherein the verifying of the business relationship includes at least one of:
using the commerce network data structure;
receiving a confirmation of the business relationship from the business entity;
receiving a communication from the first user, the communication including evidence confirming the business relationship; and
the machine-readable medium further includes automatically detecting an attribute of the business relationship using the transaction information related to the business relationship.
